(19) United States
(12) Patent Application Publication
(10) Pub. No.: US 2013/0272479 A1
(43) Pub. Date: Oct. 17, 2013

(54) LOWER END FITTING FOR NUCLEAR FUEL ASSEMBLY MADE FROM INTERSECTING METAL STRIPS

(71) Applicants: Jeffrey T Lee, Forest, VA (US); Roger R. Ridgeway, Lynchburg, VA (US); George S. Pabis, Lynchburg, VA (US)

(72) Inventors: Jeffrey T Lee, Forest, VA (US); Roger R. Ridgeway, Lynchburg, VA (US); George S. Pabis, Lynchburg, VA (US)

(21) Appl. No.: 13/597,838

(22) Filed: Aug. 29, 2012

Related U.S. Application Data
(60) Provisional application No. 61/625,386, filed on Apr. 17, 2012.

(51) Int. Cl. G21C 3/33

(52) U.S. Cl. CPC G21C 3/33
USPC 376/440

(57) ABSTRACT

A fuel assembly including a plurality of fuel rods arranged mutually in parallel wherein the fuel rods include a fissile material, a plurality of guide tubes arranged in parallel with and interspersed amongst the fuel rods, an upper end fitting connected with upper ends of the guide tubes, and a lower end fitting connected with lower ends of the guide tubes. At least one of the upper end fitting and the lower end fitting includes a grid formed by interlocking metal strips secured together at intersections between the metal strips.

This application claims the benefit of U.S. Provisional Application No. 61/625,386 filed Apr. 17, 2012. U.S. Provisional Application No. 61/625,386 filed Apr. 17, 2012 is incorporated herein by reference in its entirety.

### BACKGROUND

The following relates to the nuclear reactor arts, nuclear power generation arts, nuclear reactor hydrodynamic design arts, and related arts.

In nuclear reactor designs of the integral pressurized water reactor (integral PWR) type, a nuclear reactor core is immersed in primary coolant water at or near the bottom of a pressure vessel. In a typical design, the primary coolant is maintained in a subcooled liquid phase in a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated and rises through the central riser, discharges from the top of the central riser and reverses direction to flow downward back toward the reactor core through a downcomer annulus defined between the pressure vessel and the central riser. In the integral PWR design, at least one steam generator is located inside the pressure vessel. Some illustrative integral PWR designs are described in Thome et al., “Integral Helical-Coil Pressurized Water Nuclear Reactor”, U.S. Pub. No. 2010/0316181 A1 published Dec. 16, 2010 which is incorporated herein by reference in its entirety. Other light water nuclear reactor designs such as PWR designs with external steam generators, boiling water reactors (BWRs) or so forth, vary the arrangement of the steam generator and other components, but usually locate the radioactive core at or near the bottom of a cylindrical pressure vessel in order to increase the likelihood that the reactor core will remain submerged in coolant in a loss of coolant accident (LOCA).

The nuclear reactor core is comprised of multiple fuel assemblies. Each fuel assembly includes a number of fuel rods. Spaced vertically along the length of the fuel assembly are spacer grids which precisely define the spacing between fuel rods. At the top and bottom of the fuel assembly are an upper end fitting and a lower end fitting, respectively, providing structural support. The lower end fitting (LEF), sometimes called a lower nozzle, may be supported by a lower core support plate, support pedestals, or the like.

The lower end fitting is the entrance for coolant flow into the fuel assembly. The fuel assembly also includes guide tubes interspersed amongst the fuel rods. Control rods comprising neutron absorbing material are inserted into and lifted out of the guide tubes of the fuel assembly to control core reactivity. The guide tubes are welded to the grid assemblies and attached by fasteners to the upper and lower end fittings to form the structural support for the fuel assembly. Some illustrative fastener designs are described in “Lower End Fitting Locknut for Nuclear Fuel Assembly”, U.S. patent application Ser. No. 13/447,655 filed Apr. 16, 2012 which is incorporated herein by reference in its entirety. Most lower end fittings include a machined or cast primary structural member, and one or more other elements may be secured thereto (e.g., guide tube end plugs, filter plates, etc.). The LEF may include chamfered edges to guide the fuel assembly into the core without hanging up on other neighboring assemblies. One lower end fitting including a filter plate is disclosed in U.S. Pat. No. 5,094,802 to Riordan, which discloses a debris filter in the form of a filter plate attached to a lower end fitting.

Disclosed herein are improvements that provide various benefits that will become apparent to the skilled artisan upon reading the following.

### BRIEF DESCRIPTION

In accordance with one aspect, an apparatus comprises a fuel assembly including a plurality of fuel rods arranged mutually in parallel wherein the fuel rods include a fissile material, a plurality of guide tubes arranged in parallel with and interspersed amongst the fuel rods, an upper end fitting connected with upper ends of the guide tubes, and a lower end fitting connected with lower ends of the guide tubes. At least one of the upper end fitting and the lower end fitting includes a grid formed by interlocking metal strips secured together at intersections between the metal strips.

The intersecting metal strips can be welded together at intersections between the metal strips. The terminal ends of the interlocking metal strips can be bounded by outer strips. The grid can include a plurality of openings of equal, nearly equal, or varying sizes. The lower end fitting can include said grid formed by interlocking metal strips secured together at intersections between the metal strips. The lower ends of the guide tubes can include guide tube end plugs connected with the lower end fitting. The guide tube end plugs can include non-circular projections for mating with non-circular grid openings in the lower end fitting. The interlocking metal strips can include stamped metal strips. The interlocking metal strips can comprise stainless steel, Inconel, or a zirconium alloy.

In accordance with another aspect, an assembly comprises a plurality of spacer grids, a plurality of guide tubes extending through the spacer grids, and a lower end fitting attached to the lower ends of the guide tubes, the lower end fitting comprising a grid formed by intersecting metal strips secured together at intersections between the metal strips. The intersecting metal strips can be welded together at intersections between the metal strips. The lower end fitting does not include a machined or cast element in one exemplary embodiment. Ends of the intersecting metal strips can be at least partially bounded by one or more outer strips. In one exemplary embodiment, the metal strips do not include nuclear fuel rod retention features. In another exemplary embodiment, the metal strips do not include springs or dimples configured to engage nuclear fuel rods. The assembly can further include a bundle of fuel rods comprising fissile material held together by the spacer grids, and an upper end fitting attached to upper ends of the guide tubes, wherein the assembly including the spacer grids, guide tubes, lower end fitting, upper end fitting, and bundle of fuel rods defines a nuclear fuel assembly.

In accordance with another aspect, a method comprises arranging a plurality of metal strips in an intersecting arrangement to form a grid, securing the metal strips together at intersections between the metal strips to form an end fitting, and attaching ends of guide tubes to the end fitting. The securing can include welding the metal strips together at intersections between the metal strips. The method can further comprise forming the metal strips by a stamping process.

In accordance with still another aspect, an apparatus comprises an end fitting for a nuclear fuel assembly, the end fitting comprising an assembly of intersecting metal strips secured together at intersections between the strips. The intersecting metal strips can be welded together at intersections between the strips. In one exemplary embodiment, the metal strips do not include retention features for engaging nuclear fuel rods.

### BRIEF DESCRIPTION OF THE DRAWINGS

FIG. 1 diagrammatically shows a side view of a fuel assembly with a lower end fitting.

FIG. 2 is a perspective top view of an exemplary lower end fitting in accordance with the present disclosure.

FIG. 3 is a plan view of the exemplary lower end fitting of FIG. 2.

FIG. 4A is a side elevation view of the exemplary lower end fitting of FIG. 2.

FIG. 4B is an enlarged portion of FIG. 4A.

FIG. 5 is a partial cross-sectional view vertically through a guide tube plug of the exemplary lower end fitting of FIGS. 2 and 3.

FIG. 6 is a bottom view of the exemplary guide tube plug of FIG. 5.

### DETAILED DESCRIPTION

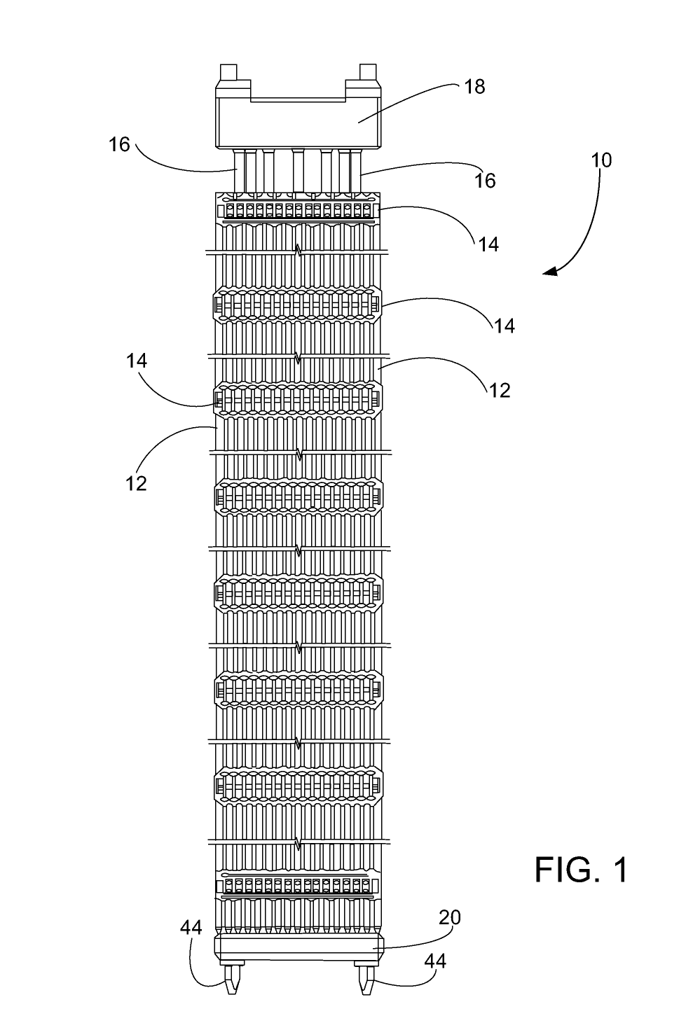

FIG. 1 illustrates a typical nuclear fuel assembly generally designated by the numeral 10. Fuel assembly 10 is typical of that used in a pressurized water reactor (PWR), boiling water reactor (BWR), or other light water nuclear reactor, and includes a plurality of fuel rods 12, spacer grids 14, guide tubes 16, an upper end fitting 18, and a lower end fitting 20. In the installed configuration the fuel rods 12 are generally vertically oriented, although some deviation from exact gravitational vertical is contemplated, for example in maritime nuclear reactors that may tilt with ocean currents or vessel maneuvers. Fuel rods 12 are maintained in an array spaced apart by spacer grids 14. Guide tubes 16 extend through spacer grids 14 and connect at their ends with the upper and lower end fittings 18, 20. The assembly of the spacer grids 14, guide tubes 16, and end fittings 18, 20 are welded together and/or attached by fasteners to form the structural skeleton of the fuel assembly 10. The guide tubes 16 are hollow tubes that serve as guides for control rods and as conduits for instrumentation or sensors (elements not shown). Upper and lower end fittings 18, 20 provide structural and load bearing support to fuel assembly 10 and have openings to allow coolant to flow vertically through the fuel assembly 10. Lower end fitting 20 may rest on a lower core support plate (not shown) of the reactor and above coolant inlet openings in the lower core support plate that direct coolant upward to the fuel assembly. Alternatively, in some embodiments upward primary coolant flow is sufficient to lift the fuel assembly during reactor operation, in which case the upper end fitting 18 (or springs built into the fitting, not shown) presses against an upper plate or other “stop”. The illustrative fuel assembly 10 is merely an example, and the fuel assembly may have different numbers of fuel rods, non-square cross-sections (e.g., a hexagonal cross-section in some embodiments), different numbers and arrangements of guide tubes, and so forth.

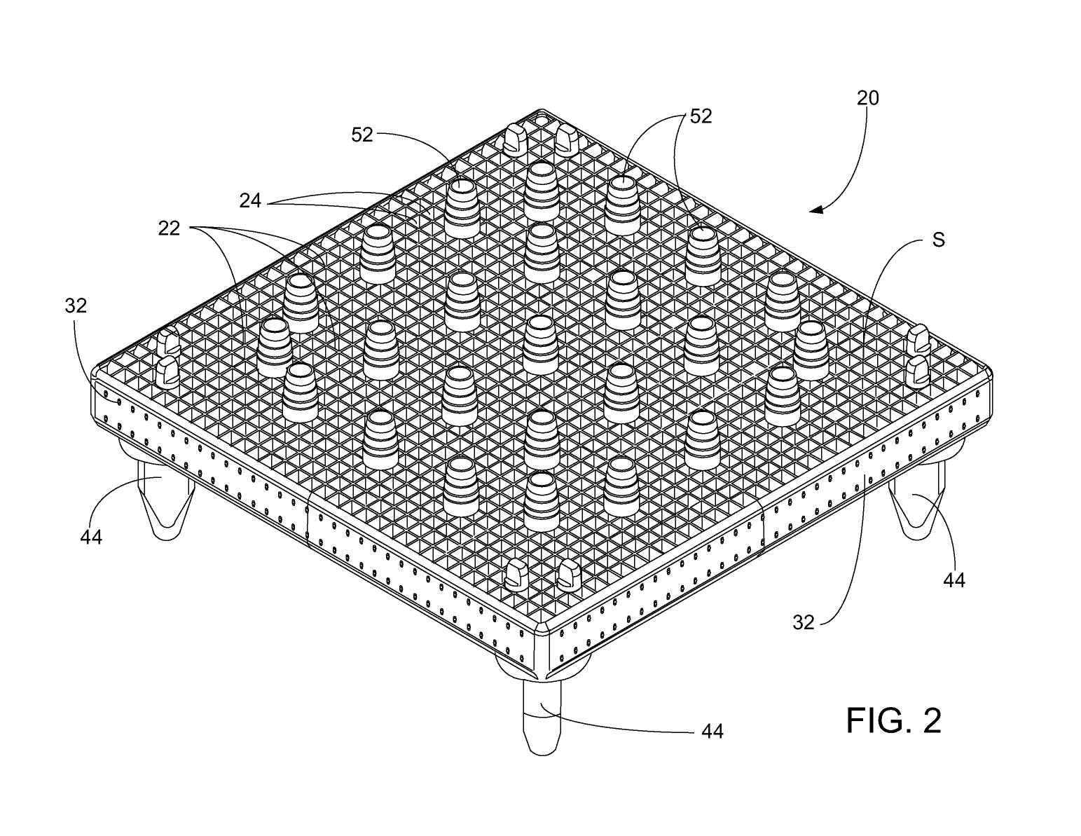

With reference to FIG. 2, lower end fitting 20 is a substantially planar square element with a plurality of intersecting and interlocking strips 22 (inner strips, sometimes also called inner straps) forming a grid S having a plurality of openings or flow channels 24 defined between the interlocking strips 22. While the illustrative lower end fitting 20 is square, more generally the lower end fitting is sized and shaped to match the cross-section of the fuel assembly 10. In the illustrated embodiment, the strips 22 intersect at right angles, thus forming flow channels having a generally square shape. The flow channels can have a variety of shapes, however, such as diamond or rectangular, depending upon the spacing and the angles of intersection of the interlocking strips 22. Moreover, the spacing of the strips, and the resulting sizes of the openings, need not be uniform across the grid S.

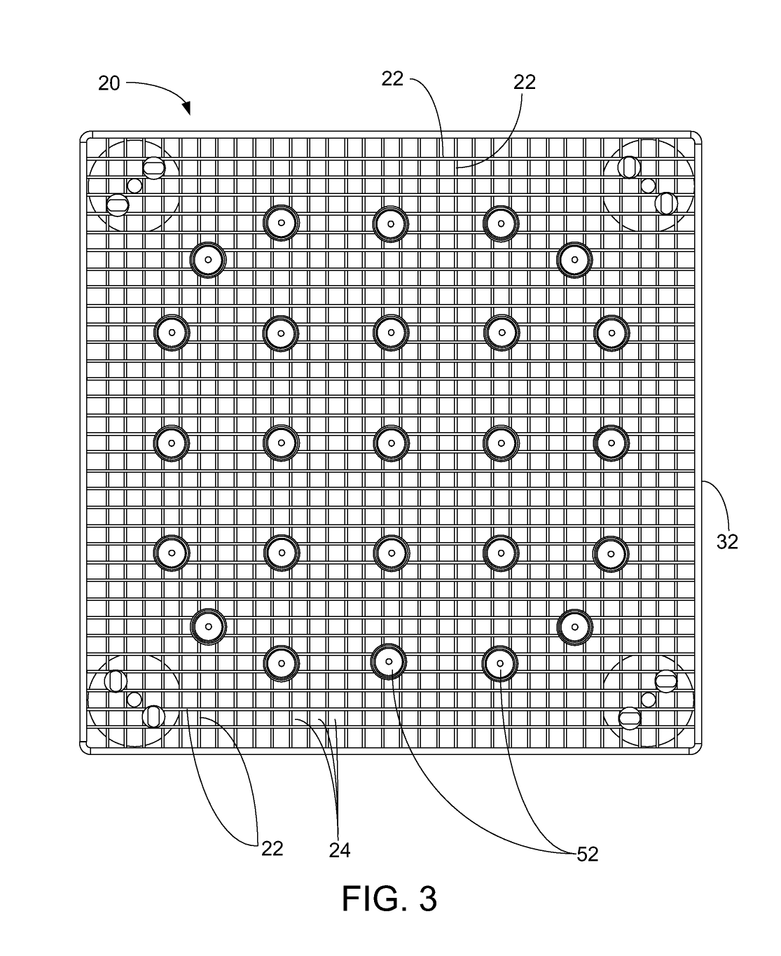

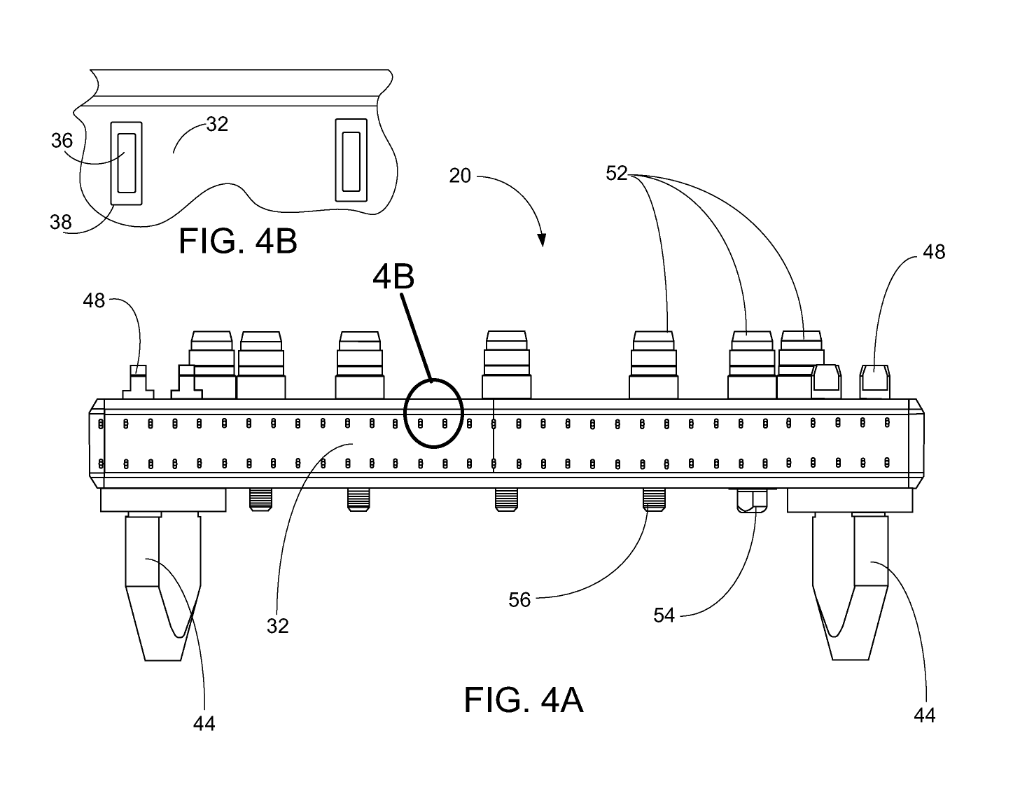

With further reference to FIGS. 3 and 4A, bounding the periphery of the grid S of interlocking strips 22 are outer strips 32 (again, sometimes called outer straps). Terminal ends of the inner strips 22 can include a pair of tabs 36 or the like that are adapted to be received into corresponding slots or holes 38 in the outer strips 32. The outer strips 32 and the interlocking (inner) strips 22 can be welded together at their interlocking intersections, as described in more detail below.

Attached to the bottom of the grid of interlocking strips are four pins 44 for aligning the fuel assembly with the lower core plate. Each of the pins 44 are secured with one or more fasteners 48, such as a bolt or the like, to the grid S. The fasteners are configured to pass through one of the flow passageways 24. Alternatively, the pins 44 can be secured to the grid S by welding or in any other suitable manner, or the pins 44 can be replaced by another support element, or the pins can be omitted and the grid can be self-supporting.

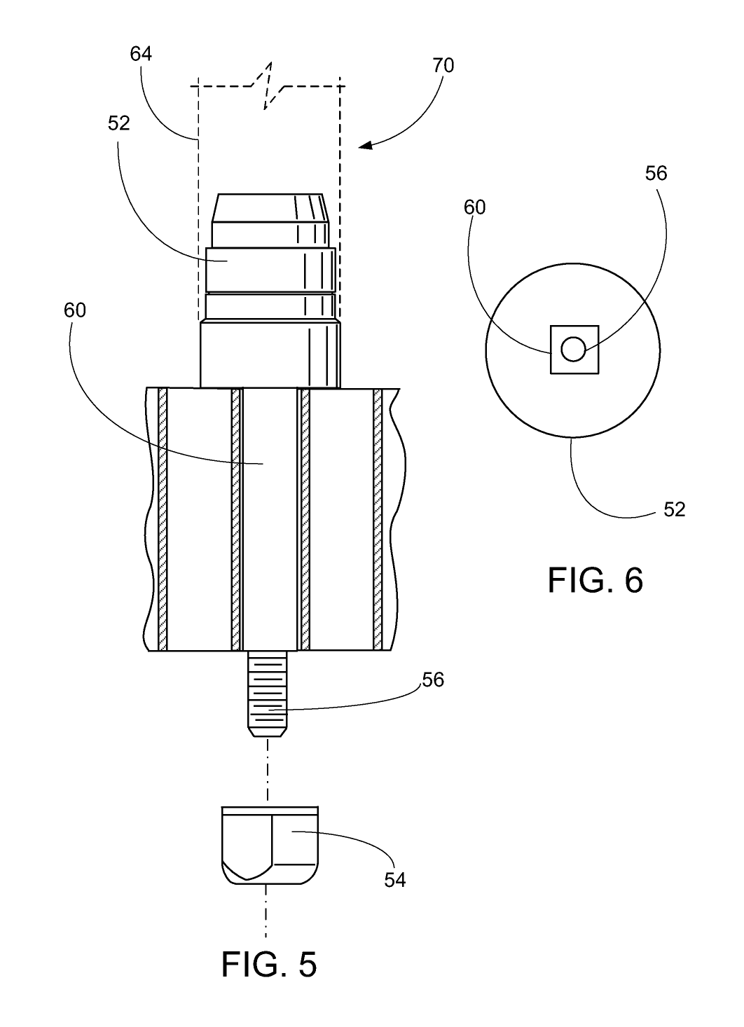

Arranged about an opposite surface of the grid S are a plurality of guide tube plugs 52 that are configured to mate with respective guide tubes 64. Guide tube plugs 52 are preferably welded to guide tubes 64 to form guide tube assembly 70 (FIG. 5.) prior to passing the guide tube plug 52 through respective flow passage 24. The guide tube plugs 52, like the feet 44, are secured to the grid S using suitable fasteners, such as nuts 54 tightened onto threaded studs of the guide tube plugs 52 that extend through respective flow passages 24, as best shown in FIG. 5. Alternatively, the guide tube plugs 52 can be secured in openings of the grid S by welding or another technique. While guide tube plugs 52 are shown, in some embodiments it is contemplated for the ends of the guide tubes to directly insert into the grid openings without a plug or other intervening element.

With reference to FIGS. 5 and 6 the guide tube plugs 52 can include an anti-rotation protrusion 60 that is adapted to be received in a flow passage 24 to prevent rotation of the guide tube assembly 70 (See FIG. 5, representative guide tube 64 shown as dotted line attached to guide tube plug 52) when secured to the grid S. The protrusion 60 has a non-circular cross-sectional shape corresponding to a shape of the flow passage 24. In the illustrated embodiment, the protrusion 60 is generally square and is adapted to be closely received within the flow passage 24. The protrusion 60 assists during installation of the guide tube assembly 70 by preventing the threaded stud 56 from rotating as the nut 54 is tightened thereon. After assembly, the protrusion 60 further acts to prevent rotation of the guide tube assembly 70 during installation and operation.

The strips 22, 32 can be made of a wide variety of materials such as stainless steel, Inconel, various zirconium alloys, or other metals or metal alloys that are robust in the reactor environment. The individual strips can be created using a stamping process. The lower end fitting is assembled from such strips, in the following exemplary manner. First, the symmetric inner strips 22 are assembled as an egg crate (i.e., to form the grid S). The strips 22 typically include cutouts, slots, or notches for interlocking the strips. Then, four outer strips 32 are attached to the perimeter of the grid S. The intersections and edges are welded by a suitable welding process, such as laser welding or the like. Outer strips 32 may be positioned such that welds between edges of outer strip 32 occur at the corners of lower end fitting 20 or at any point between corners. In some embodiments shorter or longer length outer strips may be used such that more or less than four outer strips 32 encompass the perimeter of grid S.

The disclosed lower end fitting formed from interlocking metal strips has some advantageous similarity with spacer grids, which are also sometimes constructed as an assembly of interlocking strips. Accordingly, existing manufacturing systems for constructing spacer grids, such as high-speed robotic laser welding systems, can be employed to perform analogous fabrication operations for constructing the disclosed lower end fittings. However, the disclosed lower end fittings have substantial structural and functional differences as compared with spacer grids. Unlike spacer grids, the lower end fittings disclosed herein typically do not contact or serve to space apart fuel rods, and so the interlocking strips of the lower end fitting do not include springs, dimples, or other fuel rod retention features. In the same vein, since the lower end fitting does not serve to define spacings between fuel rods, the lower end fitting can have its metal strips spaced closer together than is the case for the spacer grid, which can enhance the structural strength of the lower end fitting and can enable the openings 24 of the grid S to be sized to perform debris filtering or other useful functionality. (Conversely, if wider strip spacing versus that of the spacer grid is found to provide sufficient structural strength, then a wider spacing can be used to reduce material costs, to provide reduced flow resistance, or for other design purposes). In some embodiments, the openings 24 are sized to enable the bolt portion of a control rod tube locking apparatus to pass there through, although larger or smaller openings 24 are also contemplated. In other embodiments, the openings 24 are sized larger than the fuel rods and an additional fuel rod retention apparatus is utilized to inhibit fuel rods from downwardly ejecting through the lower end fitting.

In a variant embodiment, the lower end fitting comprising interlocking strips disclosed herein also serves as a lowermost spacer grid for the fuel rods. In this variant embodiment (not shown), the strip spacing in the lower end fitting is commensurate with the strip spacing in the spacer grids, and the lowermost ends of the fuel rods are inserted into the openings. In this case the overall height of the combined spacer grid/lower end fitting is optionally larger than the height of the single-purpose lower end fitting embodiments (e.g., as shown in FIGS. 2 and 4A), so as to have an upper portion engaging the fuel rods and a lower portion serving the lower end fitting functionality. In this case, suitable fuel rod retention features such as dimples or springs can be included in the upper portion of the strips. A disadvantage of this combined spacer grid/lower end fitting variant is that strip spacing should be commensurate with the fuel rod spacing, although additional strips providing enhanced structural strength can be provided by “doubling up” the strips, i.e. having two (or more) closely spaced strips correspond to a single strip of a conventional spacer grid.

The exemplary lower end fitting of the present disclosure has a number of manufacturing advantages over conventional lower end fittings. The exemplary lower end fitting has only two types of parts in its most basic form, inner strips 22 and outer strips 32. There are no cast or machined elements (the strips are suitably stamped, although machining is also contemplated), and no machining of the lower end fitting is required after welding is complete (although again machining is contemplated to form selected structures such as optionally cutting away strip portions to form an enlarged opening to receive an “oversized” element such as a alignment pin 44). In addition, the spacing of the inner strips 22 (and hence the size/positioning of the openings 24) can optionally be based on the fuel rod spacing so that fuel rods line up with openings (flow passages 24). This can allow for additional fuel rod growth but still prevents fuel rod ejections. An anti-rotation feature, as described herein with reference to FIG. 5, can be provided on the guide tube lower plug to nest within one or more grid squares. The lower end fitting (LEF) can be constructed using fixturing and welding methods compatible with existing spacer grid welding equipment, and low cost stamped parts are employed, as compared to the complexity of casting/machining conventional lower end plates.

In addition, the exemplary lower end fittings disclosed herein have various performance advantages over conventional machined or cast lower end fittings, such as reduced pressure drop (as compared to conventional designs) and improved distribution of flow into the fuel assembly. The LEF can provide optional debris filtering as the flow passage dimensions can be chosen based on strip dimensions and spacing to achieve desired filtering “pore size”. In an environmental aspect, the disclosed LEF is crushable for disposal thereby reducing waste volume and potentially lowering disposal costs.

It will be appreciated that various additional features are optionally implemented to achieve desired LEF functionality. For example, formed features can be included on the inner and outer strips to shape the flow distribution into the reactor core, and to provide optional debris filtering. In addition, some or all of the strips can be curved as opposed to the illustrated straight strips, for example to further tailor the flow distribution into the reactor core. Various stamped features can also be incorporated to improve performance and/or enhance assembly. As mentioned above, variations in inner strip pitch and/or thickness and/or width (e.g., height of LEF) can be used to optimize debris filtering and/or pressure drop characteristics. Sleeves can be provided to serve as mounting points for core pins and/or guide tubes (this can include cutting out a mounting area after assembly and welding of grid S and then welding the insert and weld sleeves in place).

Although described chiefly in the context of a lower end fitting, it will be appreciated that aspects of the disclosure are also applicable to upper end fittings. That is, the disclosed end fitting comprising interlocking strips can be employed as the lower end fitting (as illustrated herein) and/or as the upper end fitting.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An apparatus comprising:
a fuel assembly including:
a plurality of fuel rods arranged mutually in parallel wherein the fuel rods include a fissile material,
a plurality of guide tubes arranged in parallel with and interspersed amongst the fuel rods,
an upper end fitting connected with upper ends of the guide tubes, and
a lower end fitting connected with lower ends of the guide tubes,
wherein at least one of the upper end fitting and the lower end fitting includes a grid formed by interlocking metal strips secured together at intersections between the metal strips.

2. An apparatus as set forth in claim 1, wherein the intersecting metal strips are welded together at intersections between the metal strips.

3. An apparatus as set forth in claim 1, wherein the terminal ends of the interlocking metal strips are bounded by outer strips.

4. An apparatus as set forth in claim 1, wherein the grid includes a plurality of openings through which a bolt portion of a guide tube assembly can pass there through.

5. An apparatus as set forth in claim 1, wherein the lower end fitting includes said grid formed by interlocking metal strips secured together at intersections between the metal strips

6. An apparatus as set forth in claim 5, wherein the lower ends of the guide tubes include guide tube end plugs connected with the lower end fitting.

7. An apparatus as set forth in claim 6, wherein the guide tube end plugs include non-circular projections for mating with non-circular grid openings in the lower end fitting.

8. An apparatus as set forth in claim 1, wherein the interlocking metal strips include stamped metal strips.

9. An apparatus as set forth in claim 1, wherein the interlocking metal strips comprise stainless steel, Inconel, or a zirconium alloy.

10. An assembly comprising:
a plurality of spacer grids;
a plurality of guide tubes extending through the spacer grids; and
a lower end fitting attached to the lower ends of the guide tubes, the lower end fitting comprising a grid formed by intersecting metal strips secured together at intersections between the metal strips.

11. An assembly as set forth in claim 10, wherein the intersecting metal strips are welded together at intersections between the metal strips.

12. An assembly as set forth in claim 10, wherein the lower end fitting is not a machined or cast element.

13. An assembly as set forth in claim 10, wherein ends of the intersecting metal strips are at least partially bounded by one or more outer strips.

14. An assembly as set forth in claim 10, wherein the metal strips do not include nuclear fuel rod retention features.

15. An assembly as set forth in claim 10, wherein the metal strips do not include springs or dimples configured to engage nuclear fuel rods.

16. An assembly as set forth in claim 10, further comprising:
a bundle of fuel rods comprising fissile material held together by the spacer grids; and
an upper end fitting attached to upper ends of the guide tubes;
wherein the assembly including the spacer grids, guide tubes, lower end fitting, upper end fitting, and bundle of fuel rods defines a nuclear fuel assembly.

17. A pressurized water reactor (PWR) including:
a nuclear core comprising nuclear fuel assemblies as set forth in claim 16,
a cylindrical pressure vessel having a vertically oriented cylinder axis and containing the nuclear core immersed in primary coolant water, and
a hollow cylindrical central riser disposed concentrically with and inside the cylindrical pressure vessel, a downcomer annulus being defined between the hollow cylindrical central riser and the cylindrical pressure vessel.

18. A method comprising:
arranging a plurality of metal strips in an intersecting arrangement to form a grid;
securing the metal strips together at intersections between the metal strips to form an end fitting; and
attaching ends of guide tubes to the end fitting.

19. The method of claim 18, wherein the securing includes welding the metal strips together at intersections between the metal strips.

20. The method of claim 18, further comprising:
forming the metal strips by a stamping process.

21. An apparatus comprising:
an end fitting for a nuclear fuel assembly, the end fitting comprising an assembly of intersecting metal strips secured together at intersections between the strips.

22. The apparatus of claim 21 wherein the intersecting metal strips are welded together at intersections between the strips.

23. The apparatus of claim 21 wherein the metal strips do not include retention features for engaging nuclear fuel rods.
